(19) United States
(12) Patent Application Publication
(10) Pub. No.: US 2012/0211175 A1
(43) Pub. Date: Aug. 23, 2012

(54) 3-WAY BLIND SYSTEMS

(76) Inventors: George R. Laubshire, JR., Fairlawn, NJ (US); Mildred Wehrer, Fairlawn, NJ (US)

(21) Appl. No.: 13/081,451

(22) Filed: Apr. 6, 2011

Related U.S. Application Data
(60) Provisional application No. 61/443,809, filed on Feb. 17, 2011.

(51) Int. Cl. E06B 9/322; E06B 9/386

(52) U.S. Cl. 160/115; 160/405

(57) ABSTRACT

A 3-way blind system for windows comprising an upper frame with: internal gearing; internal roller assemblies; a cord system; an upper and lower slat module comprising rotatably-alignable slats; an upper-housing; and a lower valence. The upper and lower slat modules operate either independently or in cooperation depending on the position of the selector to open the upper slat module to allow ambient light entrance and close the lower module for privacy, or to open the lower slat module for visibility and close the upper to limit bright ambient light from entering through the window. A third selector position may cause an internal gearset to work in unison to open or close all modules simultaneously.

### CROSS-REFERENCE TO RELATED APPLICATION

The present application is related to and claims priority from prior provisional application Ser. No. 61/443,809, filed Feb. 17, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of window blinds and more specifically relates to 3-way blinds.

2. Description of the Related Art

A basic, functional element of virtually any home decor is a window. In modern society, windows can set the tone for a room creating a pleasant mood through bright, sunny light and a direct view of the outdoors. Window blinds are a type of window covering that may be used in modern residential and commercial buildings. Since windows let in sunlight, most consumers find it necessary to attach vertical or horizontal window blinds inside their windows, in order to offer necessary shade.

The most common window blinds are slat blinds, which consist of multiple horizontal slats, usually of metal, wood or vinyl, connected with string in a way that they can be rotated to allow light to pass between the slats, rotated up to about 170 degrees to hide the light, or pulled up so that the entire window is clear from the blind assembly as an obstruction to view. Additionally window blinds may used to protect the homeowner's privacy, particularly in the evening hours when light shining from overhead lights and floor lamps illuminate through the window, offering passersby a view into the home. In cities and most densely populated areas, ambient lighting is desirable to reduce electricity costs for lighting but because of the generally close proximity of other people, privacy may be compromised. Other times, a balance may be desired between blocking direct sunlight and retaining some visibility.

There are many different kinds of window blinds, using different systems and materials. There are also window blinds that use a single piece of material instead of independent slats. Window blinds may come in horizontal and vertical orientations. A typical window blind may be adjusted by rotating from an open position to a closed position by allowing the slats to overlap. Blinds may be opened and closed; however it may be difficult to selectively open different portions of the blind as desired using present embodiments.

Various attempts have been made to solve the above-mentioned problems such as those found in U.S. Pub. No. 2006/0225844 to Simon Gabriel Gittens et al; U.S. Pat. No. 4,940,070 to Scott L. Warden; and U.S. Pat. No. 6,105,652 to Ren Judkins. This prior art is representative of window blinds. None of the above inventions and patents, taken either singly or in combination, is seen to describe the invention as claimed.

Ideally, a multiple function window blind should be versatile in use and yet would operate reliably and be manufactured at a modest expense. Thus, a need exists for a reliable 3-way blind system to provide the user with variable options in privacy and natural light and to avoid the above-mentioned problems.

### BRIEF SUMMARY OF THE INVENTION

In view of the foregoing disadvantages inherent in the known window blind art, the present invention provides a novel 3-way blind system. The general purpose of the present invention, which will be described subsequently in greater detail is to provide greater functional versatility in such window blinds.

A 3-way blind system is disclosed herein comprising: an upper-housing with at least one roller assembly and at least one gear assembly which are connected via a shaft (or other suitable connector—direct or indirect); at least two slat-modules each comprising a blind-section of rotatably-alignable slats; a selector that is movable to independently manipulate at least one slat-module via at least one gear assembly (the selector comprising at least three user positions); a removable adjuster wand (manual gear manipulation means or optionally non-manual gear manipulation means may be used such as a motor); a cord system; and a lower valence.

The upper-housing houses preferably at least one roller assembly (or other cord storing/manipulating means) and at least one gear assembly. The gear assembly comprises a first gear set and a second gear set for adjusting the slat angle of each of the preferably two slat modules within the 3-way blind system. The upper-housing and the lower valence define the outer limits (vertically) of the plurality of slat-modules. The two slat-modules, may include an upper slat-module and a lower slat-module in which the upper and lower slat-modules are independently manipulatably-operable. In certain embodiments the first gear set is in operable communication with the upper slat-module via the cord system which is manipulated by the roller assembly that is mounted on the shaft and driven by the gear assembly such that the rotatably-alignable slats may be rotated between open and closed positions. In the same way, the second gear set is also in operable communication with the lower slat-module via the cord system which is manipulated by the roller assembly that is mounted on the shaft and driven by the gear assembly such that the rotatably-alignable slats may be rotated between open and closed positions. The roller assembly may be manually or non-manually operated/manipulated.

The selector is preferably slidably-movable to independently manipulate a particularized first gear set and/or a second gear set to be engaged to rotate open and/or close the upper slat-module and lower slat-modules. The selector is slidably-movable to manipulate the upper slat-module independently or dependently either from or with the lower slat-module. The selector is slidably-movable to independently manipulate the rotatably-alignable slats within the upper slat-module to the open position and the rotatably-alignable slats in the lower slat-module to the closed position, or to independently manipulate the rotatably-alignable slats within the upper slat-module to the closed position and the rotatably-alignable slats in the lower slat-module to the open position. The selector may also be slidably-moved (or non-slidably moved in alternate embodiments) to dependently manipulate the rotatably-alignable slats within the upper slat-module to an open position and the rotatably-alignable slats in the lower slat-module to the open position, or to dependently manipulate the rotatably-alignable slats within the upper slat-module to the closed position and the rotatably-alignable slats in the lower slat-module to the closed position during a single time increment. The rotatably-alignable slats are horizontally aligned with an upper and lower sash of a window in a preferred embodiment and may be vertically aligned in alternate embodiments.

The cord system may be windably spooled and unspooled by at least one roller assembly such that a relative distance between each of the plurality of rotatably-alignable slats is able to be increased or decreased into a bunched (wherein the slats are gathered such as when opened to the top) or unbunched condition. At least one gear assembly is designed to receive the removable adjuster wand such that when the removable adjuster wand is rotated, that one gear assembly is manually manipulatable causing the rotatably-alignable slats to be oriented according to user preference. The selector is able to independently manipulate the at least one slat-module via the at least one gear assembly such that the 3-way blind system is oriented according to user preference to block or allow light to enter an interior space. The cord system also comprises pull cords to raise and lower the slats in all modules simultaneously to provide an unobstructed view or to provide maximum ambient light.

The 3-way blind system may comprise a kit having a 3-way blind system; a cleaner; and a set of user instructions.

A method of use for a 3-way blind system is described herein comprising the steps of: installing the 3-way blind system; selecting an upper slat-module or a lower slat-module or both slat-modules to be opened or closed according to user preference via a selector that is slidably-movable; and rotating a removable adjuster wand to open either the upper slat-module and/or the lower slat-module as desired by the user with the optional step of changing positioning of the upper slat-module and/or the lower slat-module as desired.

The present invention holds significant improvements and serves as a 3-way blind system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, 3-way blind system, constructed and operative according to the teachings of the present invention.

FIG. 1 shows a perspective view illustrating an in use condition of a 3-way blind system according to an embodiment of the present invention.

FIG. 2 is a perspective view illustrating the 3-way blind system with a lower slat module rotated substantially downwardly (to a semi-closed position) and an upper slat module adjusted for maximum visibility according to an embodiment of the present invention of FIG. 1.

FIG. 3 is a perspective view illustrating the 3-way blind system with the upper slat module rotated substantially downward and the lower slat module adjusted for maximum visibility according to an embodiment of the present invention of FIG. 1.

FIG. 4 is a perspective view illustrating the 3-way blind system selector that is movable to independently manipulate at least one slat-module according to an embodiment of the present invention of FIGS. 1-3.

FIG. 5 is a flowchart illustrating a method of use of the 3-way blind system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a window blind system and more particularly to a 3-way blind system as used to provide the user with variable options in privacy and natural lighting.

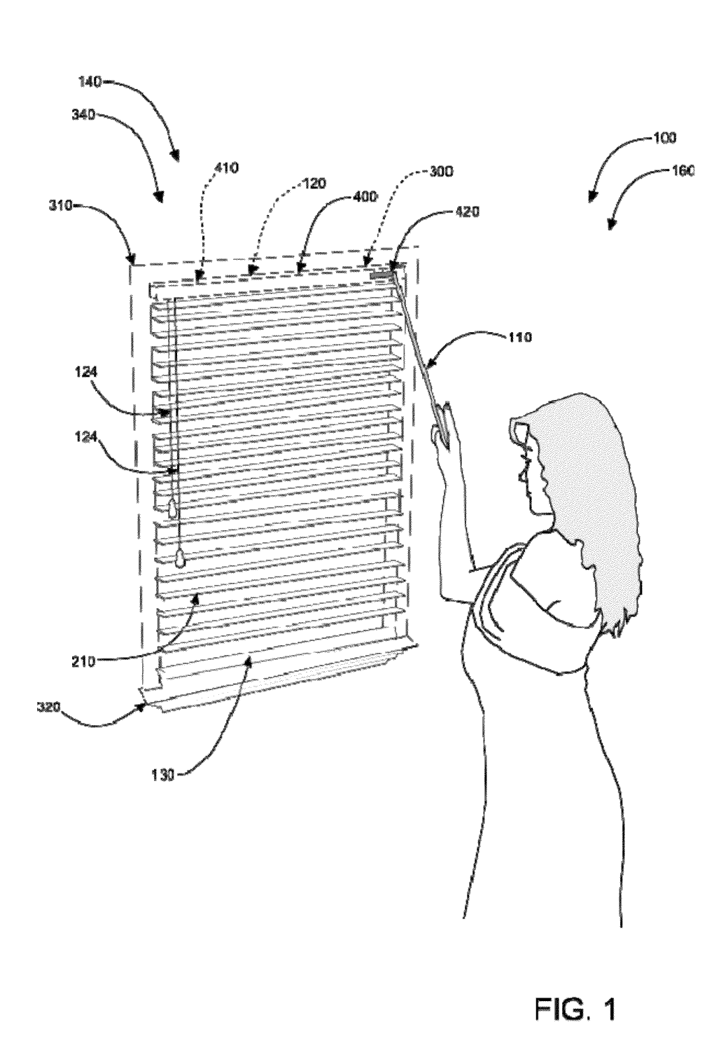

Referring to the drawings by numerals of reference there is shown in FIG. 1, a perspective view illustrating an in-use condition 160 of 3-way blind system 100 according to an embodiment of the present invention. 3-way blind system 100 preferably comprises an upper-housing 400 with at least one roller assembly 260 and at least one gear assembly 300 contained therewithin; with roller assembly 260 and gear assembly 300 being connected via shaft 410. 3-way blind system 100 also preferably comprises a plurality of slat-modules 222 each comprising a plurality of rotatably-alignable slats 210. The present invention may further comprise selector 420 that is movable to independently manipulate at least one slat module 222 via at least one gear assembly 300; at least one removable adjuster wand 110; cord system 120; and lower valence 130.

Upper-housing 400 within this particular embodiment houses at least one roller assembly 260 and at least one gear assembly 300 connected preferably via shaft 410 (or other suitable direct or indirect connection means.) Upper-housing 400 and lower valence 130 define outer limits (vertically) of the plurality of slat module(s) 222. Cord system 120 is windably spooled and unspooled by at least one roller assembly 260 such that a relative distance between each of the plurality of rotatably-alignable slats 210 is able to be increased or decreased.

3-way blind system 100 preferably comprises simple pull cords 124 in order to raise and/or lower the entire set of blinds 270 (upper slat-module 220 and lower slat-module 230.) Gear assembly 300 receives removable adjuster wand 110 such that when removable adjuster wand 110 is rotated, at least one gear assembly 300 is manually manipulated causing rotatably-alignable slats 210 slats to be oriented according to user preference. Rotatably-alignable slats 210 are preferably horizontally aligned (parallel to—as shown) with upper sash 310 and lower sash 320 of a window 340 and in other embodiments; rotatably-alignable slats are perpendicularly-aligned with an upper and lower sash of a window 340 (as in vertical versions.)

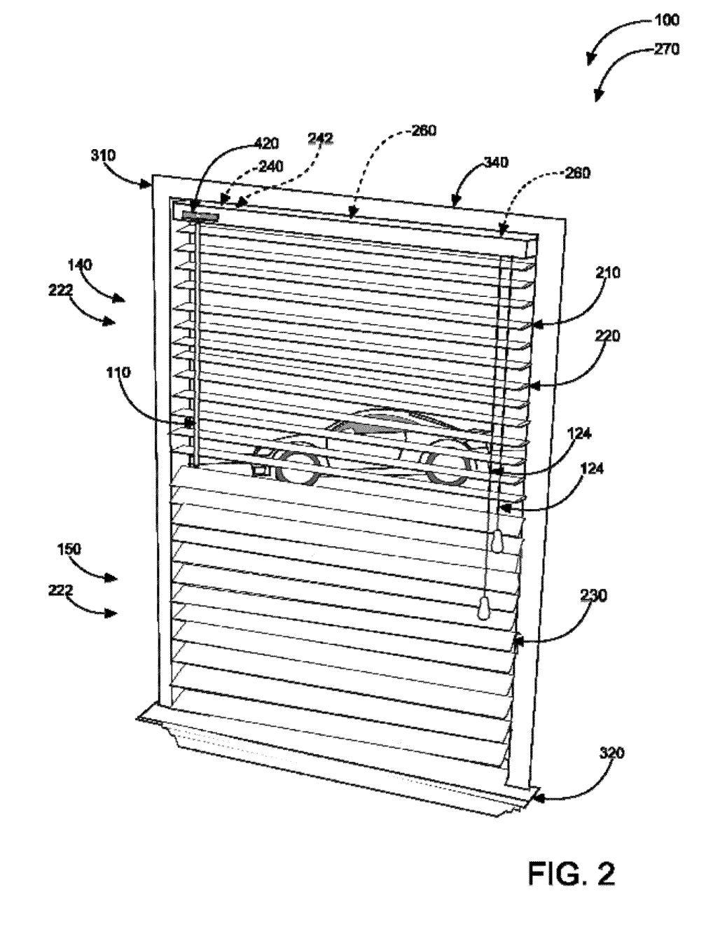

Referring now to FIG. 2, showing a perspective view illustrating 3-way blind system 100 with lower slat-module 230 rotated substantially downwardly (towards a closed position) and upper slat-module 220 adjusted for maximum visibility (horizontally-planar-orientation) according to an embodiment of the present invention of FIG. 1. With a preferred embodiment 3-way blind system 100 comprises an upper slat-module 220 and lower slat-module 230 (other alternate embodiments may comprise more than two slat modules.) 3-way blind system 100 comprises at least two slat module(s) 222 (as shown) to allow the user maximum versatility in finding a comfortable balance between ambient light, visibility, and privacy due to slat module(s) 222 that are independently, manipulatably-operable.

Operation of upper slat-module 220 and lower slat-module 230 may be achieved by gear assembly 300 which preferably comprises first gear set 240 and second gear set 242 wherein first gear set 240 is in operable communication with upper slat-module 220 via cord system 120 manipulated by roller assembly 260, gear assembly 300, and shaft 410, such that rotatably-alignable slats 210 may be rotated between open and closed positions. Second gear set 242 may be in operable communication with lower slat-module 230 via cord system 120 manipulated by roller assembly 260, gear assembly 300, and shaft 410 such that rotatably-alignable slats 210 may be rotated between open and closed positions. First gear set 240 and second gear set 242 may be operable when the system is used in a dependant mode—wherein both upper slat-module 220 and lower slat-module 230 are operated simultaneously and cooperatively.

To accomplish variably selected modes of operation, selector 420 may be slidably-movable to independently manipulate rotatably-alignable slats 210 within upper slat-module 220 to an open position and rotatably-alignable slats 210 in lower slat-module 230 to a closed position during a single time increment. Alternately, selector 420 may be slidably-movable to dependently manipulate rotatably-alignable slats 210 within upper slat-module 220 to a closed position and rotatably rotatably-alignable slats 210 in lower slat-module 230 to a closed position during a single time increment according to user preference.

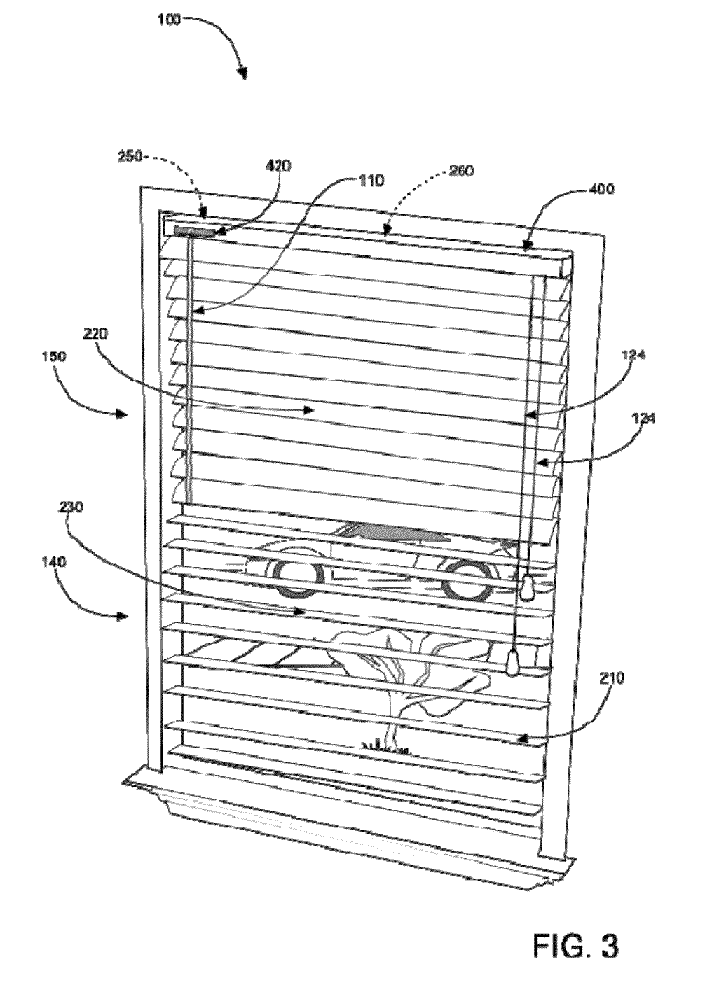

Referring now to FIG. 3, a perspective view illustrating 3-way blind system 100 with upper slat-module 220 rotated substantially downwardly and lower slat-module 230 adjusted for maximum outward visibility according to an embodiment of the present invention of FIG. 1. As discussed, selector 420 is able to independently manipulate at least one slat module(s) 222 via engaging at least one gear assembly 300 (or via other ratio rotatable/linear means) such that 3-way blind system 100 is selectively oriented according to user preference to block or allow light to enter an interior space.

Selector 420 is slidably-movable to independently manipulate rotatably-alignable slats 210 within upper slat-module 220 to a closed position and rotatably-alignable slats 210 in lower slat-module 230 to an open position during a single time increment or selector 420 is slidably-movable to dependently manipulate rotatably-alignable slats 210 within upper slat-module 220 to an open position and rotatably-alignable slats 210 in lower slat-module 230 to an open position during a single time increment according to user preference. In these ways light may be introduced or substantially prevented from entering an interior room or space.

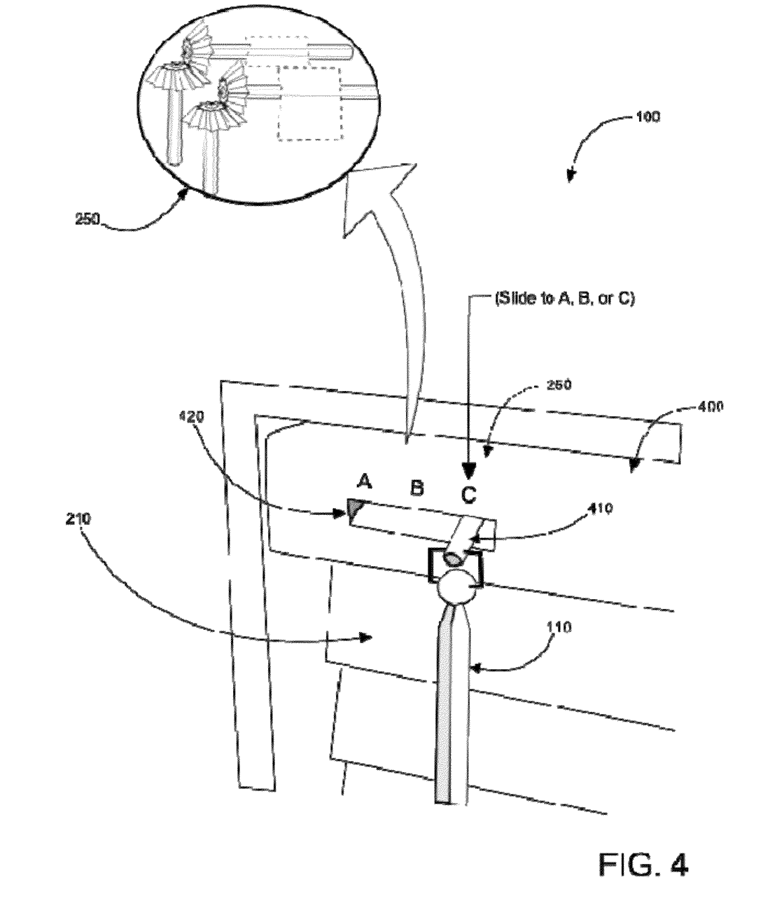

Referring now to FIG. 4, is a perspective view illustrating 3-way blind system 100 wherein selector 420 may be movable to independently manipulate at least one slat module(s) 222 according to an embodiment of the present invention of FIG. 1.

3-way blind system 100 selector 420 is slidably-movable to independently engage first gear set 240 and/or second gear set 242 to rotate open and/or close upper slat-module 220 and lower slat-module(s) 230. Selector 420 is slidably-movable to independently engage upper slat-module 220 from lower slat-module 230 and selector 420 is slidably-movable to dependently engage upper slat-module 220 and lower slat-module 230 to operate both (or all) modules together if desired by the user. In other embodiments, selector 420 may be non-slideable (such as in rheostat versions, motorized, rotation versions, other linear formations, and the like.)

3-way blind system 100 may be sold as kit 440 comprising the following parts: at least one 3-way blind system; a cleaner; and a set of user instructions. 3-way blind system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, motorized or manual versions, etc., may be sufficient.

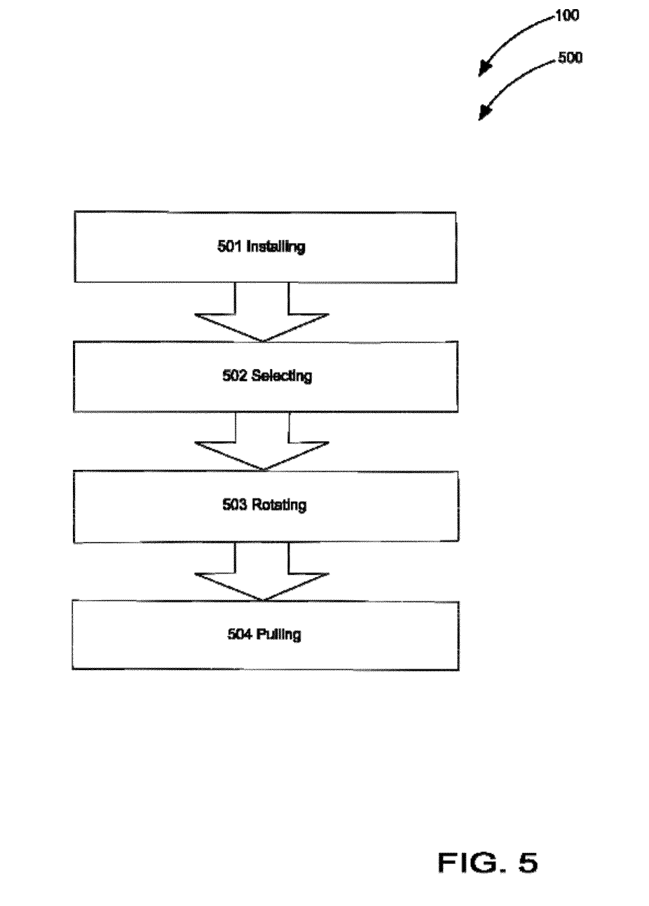

Referring now to FIG. 5, is a flowchart illustrating a method of use 500 for 3-way blind system 100 according to an embodiment of the present invention of FIGS. 1-4: (1) installing 3-way blind system 100; (2) selecting an upper slat-module 220 or lower slat-module 230 or both slat module(s) 222 to be opened or closed (according to user preference) via selector 420 that is preferably slidably-movable; and (3) rotating removable adjuster wand 110 to open desired upper slat-module 220 and/or lower slat-module 230 to open or close; and optionally (4) pulling pull cords 124 to raise or lower all slat module(s) 222 to cover window 340 or leave an unobstructed view.

It should be noted that steps 502-504 are optional steps and may not be implemented in all cases. Optional steps of method of use 500 are illustrated using dotted lines in FIG. 5 so as to distinguish them from the other steps of method of use 500.

It should be noted that the steps described in the method of use 500 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A 3-way blind system comprising:
an upper-housing comprising at least one roller assembly and at least one gear assembly, said roller assembly and said gear assembly connected via a shaft;
a plurality of slat-modules each comprising a plurality of rotatably-alignable slats;
a selector that is movable to independently manipulate at least one slat-module via said at least one gear assembly;
at least one removable adjuster wand;
a cord system; and
a lower valence;
wherein said upper-housing houses said at least one roller assembly and said at least one gear assembly connected via said shaft;
wherein said upper-housing and said lower valence define outer limits of said plurality of slat-modules;
wherein said cord system is windably spooled and unspooled by said at least one roller assembly such that a relative distance between each of said plurality of rotatably-alignable slats is able to be increased or decreased;
wherein said at least one gear assembly receives said removable adjuster wand such that when said removable adjuster wand is rotated, said at least one gear assembly is manually manipulated causing said rotatably-alignable slats to be oriented according to user preference; and
wherein said selector is able to independently manipulate said at least one slat-module via engaging said at least one gear assembly such that said 3-way blind system is selectively oriented according to user preference to block or allow light to enter an interior space.

2. The 3-way blind system of claim 1 wherein said 3-way blind system comprises at least two said slat-modules.

3. The 3-way blind system of claim 2 wherein said slat-modules are independently manipulatably-operable.

4. The 3-way blind system of claim 3 wherein said 3-way blind system comprises an upper slat-module and a lower slat-module.

5. The 3-way blind system of claim 4 wherein said gear assembly comprises a first gear set and a second gear set.

6. The 3-way blind system of claim 5 wherein said first gear set is in operable communication with said upper slat-module via said cord system manipulated by said roller assembly, said gear assembly and said shaft such that said rotatably-alignable slats may be rotated between open and closed positions.

7. The 3-way blind system of claim 5 wherein said second gear set is in operable communication with said lower slat-module via said cord system manipulated by said roller assembly, said gear assembly and said shaft such that said rotatably-alignable slats may be rotated between open and closed positions.

8. The 3-way blind system of claim 5 wherein said selector is slidably-movable to independently engage said first gear set and/or said second gear set to rotate open and/or close said upper slat-module and said lower slat-module(s).

9. The 3-way blind system of claim 5 wherein said selector is slidably-movable to independently engage said upper slat-module from said lower slat-module.

10. The 3-way blind system of claim 5 wherein said selector is slidably-movable to dependently engage said upper slat-module and said lower slat-module.

11. The 3-way blind system of claim 9 wherein said selector is slidably-movable to independently manipulate said rotatably-alignable slats within said upper slat-module to an open position and said rotatably-alignable slats in said lower slat-module to a closed position during a single time increment.

12. The 3-way blind system of claim 9 wherein said selector is slidably-movable to independently manipulate said rotatably-alignable slats within said upper slat-module to an closed position and said rotatably-alignable slats in said lower slat-module to an open position during a single time increment.

13. The 3-way blind system of claim 10 wherein said selector is slidably-movable to dependently manipulate said rotatably-alignable slats within said upper slat-module to an open position and said rotatably-alignable slats in said lower slat-module to an open position during a single time increment.

14. The 3-way blind system of claim 10 wherein said selector is slidably-movable to dependently manipulate said rotatably-alignable slats within said upper slat-module to a closed position and said rotatably-alignable slats in said lower slat-module to a closed position during a single time increment.

15. The 3-way blind system of claim 1 wherein said rotatably-alignable slats are horizontally aligned with an upper and lower sash of a window.

16. The 3-way blind system of claim 1 wherein said rotatably-alignable slats are perpendicularly-aligned with an upper and lower sash of a window.

17. A 3-way blind system comprising:
an upper-housing comprising at least one roller assembly and at least one gear assembly, said roller assembly and said gear assembly connected via a shaft;
at least two slat-modules each comprising a blind-section of rotatably-alignable slats;
a selector that is movable to independently manipulate at least one slat-module via said at least one gear assembly;
a removable adjuster wand;
a cord system; and
a lower valence;
wherein said upper-housing houses said at least one roller assembly and said at least one gear assembly;
wherein said gear assembly comprises a first gear set and a second gear set;
wherein said upper-housing and said lower valence define outer limits of said plurality of slat-modules;
wherein said 3-way blind system comprises two said slat-modules, including an upper slat-module and a lower slat-module;
wherein said slat-modules are independently manipulatably-operable;
wherein said first gear set is in operable communication with said upper slat-module via said cord system manipulated by said roller assembly, said gear assembly and said shaft such that said rotatably-alignable slats may be rotated between open and closed positions;
wherein said second gear set is in operable communication with said lower slat-module via said cord system manipulated by said roller assembly, said gear assembly and said shaft such that said rotatably-alignable slats may be rotated between said open and closed positions;
wherein said selector is slidably-movable to independently manipulate a particular said first gear set and/or said second gear set to be engaged to rotate open and/or close said upper slat-module and said lower slat-modules;
wherein said selector is slidably-movable to manipulate said upper slat-module independently or dependently from/with said lower slat-module;
wherein said selector is slidably-movable to independently manipulate said rotatably-alignable slats within said upper slat-module to said open position and said rotatably-alignable slats in said lower slat-module to said closed position, or to independently manipulate said rotatably-alignable slats within said upper slat-module to said closed position and said rotatably-alignable slats in said lower slat-module to said open position, or to dependently manipulate said rotatably-alignable slats within said upper slat-module to said open position and said rotatably-alignable slats in said lower slat-module to said open position, or to dependently manipulate said rotatably-alignable slats within said upper slat-module to said closed position and said rotatably-alignable slats in said lower slat-module to said closed position during a single time increment;
wherein said rotatably-alignable slats are horizontally aligned with an upper and lower sash of a window;
wherein said cord system is windably spooled and unspooled by said at least one roller assembly such that a relative distance between each of said plurality of rotatably-alignable slats is able to be increased or decreased into a bunched or unbunched condition;
wherein said at least one gear assembly receives said removable adjuster wand such that when said removable adjuster wand is rotated, said at least one gear assembly is manually manipulated causing said rotatably-alignable slats to be oriented according to user preference; and
wherein said selector is able to independently manipulate said at least one upper and/or lower said slat-module via said at least one gear assembly such that said 3-way blind system is oriented according to user preference to block or allow light to enter an interior space.

18. The 3-way blind system of claim 17 comprising a kit having said 3-way blind system; a cleaner; and a set of user instructions.

19. A method of use for a 3-way blind system comprising the steps of:
installing said 3-way blind system;
selecting an upper slat-module or a lower slat-module or both slat-modules to be opened or closed according to user preference via a selector that is slidably-movable; and
rotating a removable adjuster wand to open desired said upper slat-module and/or said lower slat-modules.

20. The method of claim 19 further comprising the optional step of changing positioning of said upper slat-module and/or said lower slat-modules as desired.
